(19) United States
(12) Patent Application Publication
(10) Pub. No.: US 2008/0029193 A1
(43) Pub. Date: Feb. 7, 2008

(54) Tire Tread Comprising Zigzag Incisions And Blades For Molding Such Incisions

(76) Inventors: Frederic Perrin, Beaumont (FR); Jean-Marie Mus, Marsat (FR); Elisabeth Michaudet, Riom (FR); Bruno Martin, Combronde (FR)

Correspondence Address: COHEN, PONTANI, LIEBERMAN & PAVANE, 551 FIFTH AVENUE, SUITE 1210, NEW YORK, NY, 10176, US

(21) Appl. No.: 11/629,957

(22) PCT Filed: May 27, 2005
(86) PCT No.: PCT/EP05/52434

§ 371 Date: Dec. 18, 2006

(30) Foreign Application Priority Data
Jun. 16, 2004 (FR) 0406548

(51) Int. Cl. B60C 11/12; B29C 33/42

(52) U.S. Cl. 152/209.18; 164/6

(57) ABSTRACT

A tire tread comprising a tread pattern composed of a plurality of elements in relief in the form of blocks and/or ribs defined by grooves. A plurality of these elements in relief are provided with at least one incision oriented at an average orientation defined as being the angle between a straight line passing through the ends of the incision on the running surface and the transverse direction of the tread, each incision being limited by walls of rubber mix and comprising at least two portions the average orientations of which, measured relative to the transverse direction, are different from the average orientation of the incision. On at least some of said portions having an orientation different from the average orientation of the incision, there is formed, on at least one of the walls defining the incision, at least one protuberance locally reducing the width of the incision by at least 50% of its greatest width (E).

The invention relates to treads for tires, and in particular the incisions with which such treads are provided.

A tire comprises a tread the surface radially to the outside of which, which is referred to as the rolling surface, corresponds to the surface of the tire which is intended to come into contact with the roadway during travel of the tire. This tread comprises on its rolling surface a tread pattern formed of elements in relief, ribs and/or blocks, which are separated from each other in the transverse and/or circumferential direction by cutouts in the form of grooves of transverse and/or circumferential general orientation.

For travel on ground which has been made slippery, in particular by the presence of water, it is known to provide the elements in relief of the tread pattern of a tread with a greater or lesser number of incisions, that is to say cutouts of low width compared with the widths of the grooves (“groove” is understood to mean a cutout of average width greater than or equal to 2 mm). An incision corresponds to the space defined by faces of rubber material which are located opposite one another and spaced apart by an average distance which may vary as a function of the position of the incision in the tire when the latter is traveling.

The entire advantage of the presence of a large number of incisions lies in the formation of a large number of ridges at the intersection of the faces defining each incision with the running surface of the tread.

As a general rule, the consequence of the presence of an incision opening on to the running surface of the tread, this incision having an average direction defined as the rectilinear direction passing through its ends on the running surface, is a reduction in the rigidity of the tread pattern element in which said incision is formed.

Because of this, and taking into account the necessity of having a large number of ridges of rubber mix formed by the intersection of the walls defining the incisions, the tread provided with a plurality of incisions exhibits a very significant reduction in its rigidity in a direction parallel and a direction perpendicular to the average direction of the incisions (reduction in the shearing rigidity under a force tangent to the surface of the elements in relief when passing into contact). In practice, a tread may comprise a plurality of incisions all having substantially the same orientation. Perpendicular to this orientation, there is a need to find an appropriate level of rigidity.

It is known to produce incisions the shape of which is undulating or zigzag at least in one direction (either the direction of the depth, or in the direction of the length of the incision, or in both directions). This type of incision in no way reduces the variation in rigidity in a direction perpendicular to the average direction of the incision.

The subject of the invention is a tread provided with a plurality of incisions creating a great length of ridges while limiting the reduction in rigidity and in particular in a direction perpendicular to the average direction of the incision.

To this end, the tread according to the invention comprises a tread pattern the outer part of which forms a running surface intended to come into contact with the road during travel of a tire fitted with said tread, this tread pattern being composed of a plurality of elements in relief in the form of blocks and/or ribs, these tread pattern elements being defined by grooves. Furthermore, a plurality of these elements in relief are provided with at least one incision of a width less than the width of the grooves, each incision being oriented at an average orientation (from 0° to 90°) defined as being the angle between a straight line passing through the ends of the incision on the running surface and the transverse direction of the tread (this direction corresponds to the axial direction along the axis of rotation of a tire fitted with the tread according to the invention). Each incision is limited by walls of rubber mix and comprises at least two portions the average orientation of which, measured relative to the transverse direction, is different from the average orientation of the incision. This tread is characterized in that over at least some of said portions having an orientation different from the average orientation of the incision, there is formed, over at least one of the walls defining the incision, at least one protuberance locally reducing the width of the incision by at least 50% of its greatest width so as to create by bringing together a contact limiting the deformation in the direction perpendicular to the average direction (or average orientation) of the incision.

Preferably, the total surface area of protuberance from a wall is at most equal to 60% of the total surface area of the wall.

Due to this incision geometry, it is possible to reduce significantly the relative displacements of the walls of an incision relative to the facing walls: when passing into the zone of contact with the roadway, the closure of the incision is made more effective still by the local reduction in its width while maintaining a sufficient length of ridges in the portions of the incision which do not close completely.

“Total surface area of protuberance from a face” is understood to mean the total of the surface areas of all the protuberances of one and the same face. The surface area of a protuberance corresponds to the surface area on the face in question limited by the contour of said protuberance.

Preferably, the protuberance(s) from one and the same wall are distributed between the rolling surface and a depth equal to 60% of the depth of the incision measured on this wall starting from the outer surface of the tire.

Advantageously, the angle of the walls provided with protuberances with the average orientation of the incision is at least equal to 15°. “Angle of a wall” is understood to mean the angle formed by the trace on the running surface of the wall in question.

One advantageous variant consists of providing the facing walls of one and the same portion of incision with protuberances which face one another. In another advantageous variant, while having a reduction in the width of the incision compared with the maximum width of this incision, there is formed, on the wall facing a wall comprising at least one protuberance, a hollow in which said protuberance lodges as it passes into contact in order to reduce further still the variation in rigidity owing to the presence of the incision.

In another variant, provision is made to provide at least some of the walls with an area of roughness which reinforces the effect of limiting the relative movements between said walls when the latter close again on passing into the zone of contact with the roadway. This area of roughness may, for example, be in the form of a plurality of grooves and/or ribs oriented in particular in the direction of the depth of the incision (that is to say in a direction forming an angle of 90° with the trace of the incision on the outer surface of the tire) or in any other direction. These grooves may be formed on part of the surface of the walls defining the incision or over the whole of said surface.

The invention is advantageous since it is henceforth possible to design a tread pattern provided with a plurality of incisions of oblique average orientation (that is to say, the average orientation of which is of between 15° and 50° with the axial or transverse direction on the tire) without for all that having an excessive reduction in rigidity which might possibly be harmful as far as some types of performance expected of a tire and in particular a passenger-vehicle tire are concerned.

In another variant, at least some of the incisions are defined by facets furthermore having different inclinations in the direction of the thickness of the tread; viewed in section in a plane perpendicular to the average direction of the incision, said facets exhibit zigzag or undulating traces. Provision may advantageously be made for these facets to be in part provided with at least one protuberance locally reducing the width of the incision by at least 50% of its width, the total surface area of protuberance from a facet being at most equal to 60% of the total surface area of the facet. This embodiment is particularly advantageous from the point of view of producing a strip intended to mould the incision and also from the point of view of resistance to molding forces: this is because it is essential to be able to retain the geometry of the strip despite a large number of molding operations and very particularly in the case of a strip of low thickness (less than 0.6 mm).

The invention also proposes a strip of average thickness for molding an incision, said strip comprising a plurality of parts forming undulations or zigzags in a first direction XX′ and undulations or zigzags in a second direction YY′, the latter direction being perpendicular to the direction XX′, this strip comprising hollowed parts reducing the thickness of the incision by at least 50%.

One method of obtaining such an incision consists for example of forming a strip and removing the appropriate quantity of metal to create hollows intended for molding protuberances on a tread and then of imparting thereto a zigzag general form by punching. The hollows thus formed are closed by a very fine web intended for molding the parts of low width of the incision.

Other characteristics and advantages of the invention will become apparent from the description given hereafter with reference to the appended drawings, which show, by way of non-limitative examples, forms of embodiment of the subject of the invention.

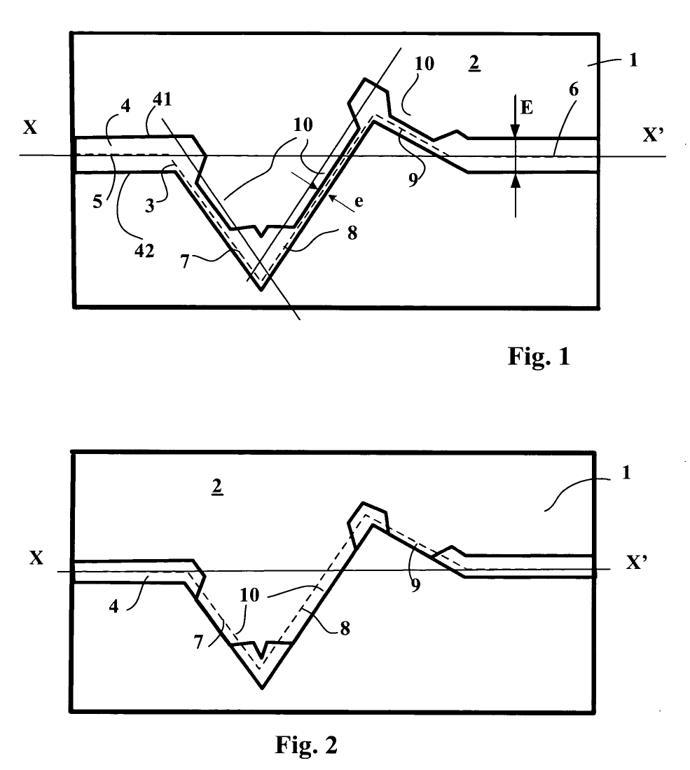

FIG. 1 shows the surface of a tread pattern element of a tread comprising an incision according to the invention;

FIG. 2 shows the same view as FIG. 1 in the contact of a tire with the ground;

FIG. 3 shows a variant of a strip intended for molding an incision according to the invention;

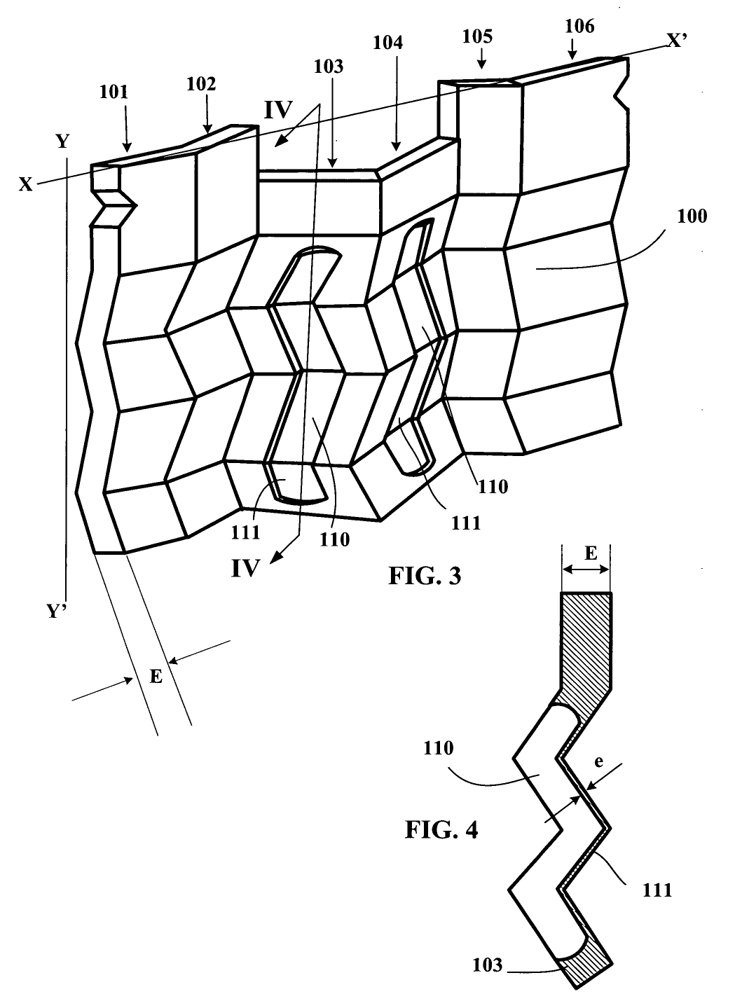

FIG. 4 shows a section taken along the line IV-IV of FIG. 3;

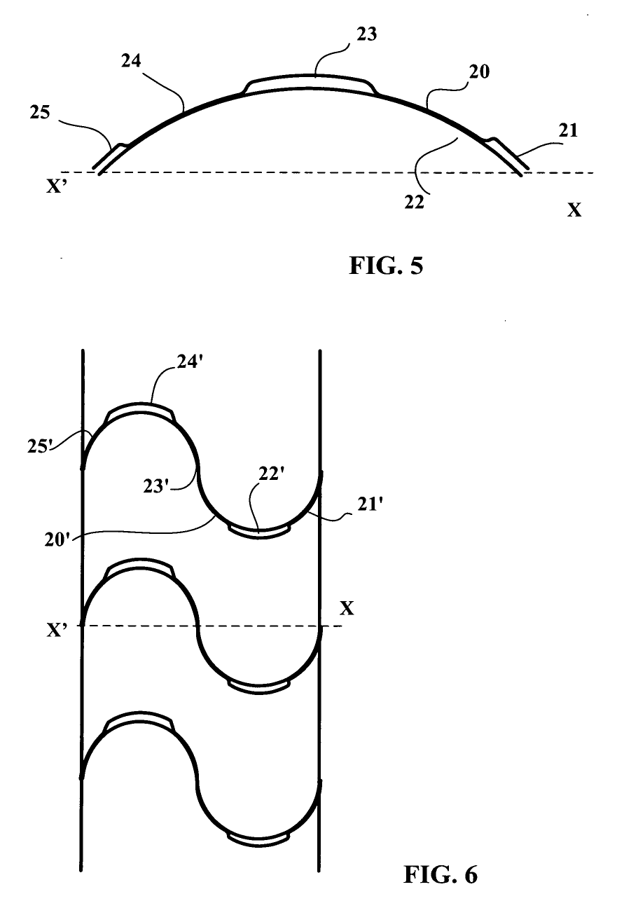

FIG. 5 shows a variant embodiment of an incision according to the invention;

FIG. 6 shows a rib comprising a plurality of incisions according to another variant of the invention.

In FIG. 1, there is depicted, in a plan view, the contact surface 2 of an element in relief (tread pattern block) of a tread according to the invention. This contact surface 2 forms part of the rolling surface of said tread. There can be seen the trace 3 of an incision 4 of average orientation XX′ forming a zero angle with the transverse direction of the tread (this direction is the same as the direction of the axis of rotation when the tread is fitted on a tire).

“Trace” is understood to mean an imaginary average line traced on the running surface substantially equidistant from the ridges 41, 42 of the walls of rubber mix defining the incision and intersecting the contact surface 2.

In the case illustrated, this trace 3 remains unchanged within the thickness of the tread; this means that the trace is the same whatever the state of wear of the tread (new, half-worn).

This trace 3 comprises end parts 5, 6 having the same orientation as the average orientation XX′ of the incision and intermediate parts 7, 8, 9 forming angles of 45° with said average orientation XX′.

On each of the walls defining the incision 4 and the traces of which form the intermediate parts 7, 8, 9 on the running surface, there is provided a protuberance 10 intended to reduce the width (or equivalently the thickness) of the incision by the order of 70%. The maximum width E of the incision is here 0.6 mm, whereas the minimum width e is 0.2 mm in its narrow part.

FIG. 2 depicts the same incision 4 as it passes into the zone of contact with the roadway: it will be noted that, on the walls comprising at least one protuberance 10, the contact is established between the facing walls, which, owing to the frictional forces which then are developed between said walls, makes it possible to increase the shearing rigidity in directions different from the average direction of the incision and hence to regain a rigidity in a direction perpendicular to said average direction XX′ of the incision.

FIG. 3 shows a strip 100 for molding an incision according to the invention. This metal strip 100 has an average maximum thickness E of 0.6 mm (this thickness is substantially equal to the width of the incision molded with this strip). This strip 100 has a zigzag general geometry in two main directions. The first direction, XX′, corresponds to the direction of the trace of the incision molded with this strip on the running surface; the second direction, YY′, corresponds to a direction perpendicular to the direction XX′ and equivalent to the direction of the thickness of the tread within which the incision is molded with the strip 100. An incision molded with this strip 100 has a trace on the tread which has a zigzag form, and furthermore a zigzag form in the depth of the tread.

The strip 100 shown comprises a succession of six parts referenced 101 to 106 in the direction XX′. Each of these strip parts is itself formed in the direction YY′ by a succession of facets forming between them angles other than 180°.

In the example represented very diagrammatically, the first facets of each of the parts 101, 102, 103, 104, 105, 106 are intended to be fixed in a mould, the other facets being intended to mould an incision in a tread. On the facets of the central parts 103 and 104 there has been machined a recess or hollowed zone 110 such that a web of metal 111 of low thickness is preserved for molding a narrow incision part. The thickness of this web 111 is less than 0.1 mm, or even less than 0.05 mm. Preferably the surface area of a recess is at most equal to 50% of the surface area of the strip part on which it is produced (in the present case of the order of 30%).

FIG. 4 shows a section along the line IV-IV of the strip 100 shown in FIG. 3. The section plane selected passes through the recess 110. One advantage of this type of strip is that it is thus possible to obtain very small thicknesses (less than 0.1 mm) locally while retaining an overall rigidity of the strip 100 which is sufficient to permit a large number of moldings of incisions in a tread of rubber material. This advantage is particularly attractive in the case of strips having undulations or zigzags in the direction YY′ (direction of the thickness of the tread) which are thus particularly sensitive to the molding forces.

To obtain such a strip, the procedure is as follows:
machining into a metal plate having the average thickness of the desired strip and at the locations provided at least one hollowed part while retaining a web of metal of a thickness of less than 50% of the maximum average thickness of said plate;
shaping of the metal plate provided with at least one hollowed part in the general shape of the strip comprising a plurality of undulations or zigzags in two different directions (for example, in two directions perpendicular to one another).

In FIG. 5 there is shown, in a plan view on the running surface of a tread, the trace 20 of an incision of average orientation XX′ and of cylindrical general geometry (the axis of this cylinder is substantially perpendicular to the rolling surface). The direction XX′ forms a zero angle with the transverse direction of the tread. Within the thickness of the tread (that is to say perpendicular to the plane of the figure) the incision exhibits undulations limiting the relative movements of the opposing faces.

This trace in the form of an arc of a circle comprises two intermediate parts 22, 24 having on the corresponding parts of the incision widths which are reduced compared with the average width of the other parts of the incision (end parts 21, 25, median part 23). The intermediate parts 22, 24 have traces on the running surface which have an orientation which is of between 10° and 30° in the case illustrated (“orientation” is understood here to mean the angle formed by a straight line tangent at any point of the part in question).

In another incision variant according to the invention depicted in FIG. 6, the incision comprises two cylindrical parts arranged in the extension of one another to form an S-shaped trace 20′ on the running surface of the tread. The average orientation of this incision corresponds to a straight line XX′ passing through the end points of the trace of the incision. This trace 20′ comprises three regions 21′, 23′ and 25′ of a width which is reduced compared with the widths of the two regions 22′ and 24′ defined as being regions for which the straight lines tangent at any point of their trace form angles which are small or even zero (“small” is understood here to mean an angle smaller than 10°) with the average direction XX′ of the incision. The average direction XX′ is the same as the transverse direction of the tread (that is to say a direction perpendicular to the longitudinal direction on the tread).

Of course, the invention is not limited to the examples described and shown, and various modifications can be made thereto without departing from the scope thereof.

1. A tire tread comprising a tread pattern the outer part of which forms a running surface intended to come into contact with the roadway during travel of a tire fitted with said tread, this tread pattern being composed of a plurality of elements in relief 1 in the form of blocks and/or ribs defined by grooves, a plurality of these elements in relief being provided with at least one incision having a maximum width (E) less than the width of the grooves, each incision being oriented at an average orientation XX′ defined as being the angle between a straight line passing through the ends of the incision on the running surface and the transverse direction of the tread, each incision being limited by walls of rubber mix and comprising at least two portions the average orientations of which, measured relative to the transverse direction, are different from the average orientation of the incision, this tread being characterized in that there is formed, at least on some of said portions having an orientation different from the average orientation of the incision, at least one protuberance locally reducing the width of the incision by at least 50% of its greatest width (E) to permit frictional contact between the opposing walls at least in the contact of the tread with the roadway.

2. The tread according to claim 1 wherein the total surface area of protuberance from a wall is at most equal to 60% of the total surface area of the wall of the incision.

3. The tread according to claim 2 wherein the angle of the walls provided with protuberances with the average orientation of the incision is at least equal to 15 degrees.

4. The tread according to one of claim 1 wherein at least some of the walls defining an incision are provided with an area of roughness which reinforces the effect of limiting the relative movements between said walls.

5. The tread according to claim 4 wherein the area of roughness comprises a plurality of ribs oriented substantially at 90 degrees relative to the trace of the incision on the running surface, on at least one wall defining an incision.

6. The tread according to claim 1 wherein it comprises a plurality of incisions the average orientation XX′ of which forms an angle of between 15 degrees and 50 degrees with the transverse direction.

7. The tread according to claim 1 wherein the incisions at least one wall of which is provided with a protuberance have zigzag forms, viewed in section in a plane perpendicular to the average direction of the incision.

8. A strip of average thickness E for molding an incision as defined in claim 1, this strip comprising a plurality of parts forming undulations or zigzags in a first direction XX′ and undulations or zigzags in a second direction YY′, the latter direction being perpendicular to the direction XX′, this strip 100 comprising hollowed parts reducing the thickness of the incision by at least 50%.

9. A process for obtaining a strip intended for molding an incision as defined in the tread according to claim 1, wherein this process comprises steps of:
machining into a metal plate and at the locations provided at least one hollowed part while retaining a web of metal of a thickness of less than 50% of the maximum average thickness of said plate; and
shaping of the metal plate provided with at least one hollowed part in accordance with the general shape of the strip comprising a plurality of undulations or zigzags in two different directions.
